(19) United States
(12) Patent Application Publication
(10) Pub. No.: US 2026/0225088 A1
(43) Pub. Date: Aug. 6, 2026

(54) AMMONIA SYNTHESIS CATALYST, AMMONIA PRODUCTION DEVICE, AND AMMONIA PRODUCTION METHOD

(71) Applicants: IDEMITSU KOSAN CO.,LTD., Chiyoda-ku, Tokyo (JP); THE UNIVERSITY OF TOKYO, Bunkyo-ku, Tokyo (JP); KYUSHU UNIVERSITY, NATIONAL UNIVERSITY CORPORATION, Fukuoka-shi, Fukuoka (JP)

(72) Inventors: Kosuke KAMOCHI, Chiyoda-ku, Tokyo (JP); Yuma ISHITOBI, Chiyoda-ku, Tokyo (JP); Norio TOMOTSU, Chiyoda-ku, Tokyo (JP); Yoshiaki NISHIBAYASHI, Bunkyo-ku, Tokyo (JP); Kazuya ARASHIBA, Bunkyo-ku, Tokyo (JP); Kazunari YOSHIZAWA, Fukuoka-shi, Fukuoka (JP); Akihito EGI, Fukuoka-shi, Fukuoka (JP)

(73) Assignees: IDEMITSU KOSAN CO.,LTD., Chiyoda-ku, Tokyo (JP); THE UNIVERSITY OF TOKYO, Bunkyo-ku, Tokyo (JP); KYUSHU UNIVERSITY, NATIONAL UNIVERSITY CORPORATION, Fukuoka-shi, Fukuoka (JP)

(21) Appl. No.: 19/150,901

(22) PCT Filed: Jan. 25, 2024
(86) PCT No.: PCT/JP2024/002243

§ 371 Date: Jul. 24, 2025

(30) Foreign Application Priority Data
Jan. 25, 2023 (JP) 2023-009574

(51) Int. Cl. B01J 31/22; B01J 31/24; B01J 35/33; B01J 37/04; C01C 1/04; C25B 1/27; C25B 11/048

(52) U.S. Cl. CPC B01J 31/22; B01J 31/2476; B01J 35/33; B01J 37/04; C01C 1/0411; C25B 1/27; C25B 11/048; B01J 2231/62; B01J 2531/004; B01J 2531/0244; B01J 2531/64

(57) ABSTRACT

The ammonia synthesis catalyst of the present invention is a complex containing metal ions and a ligand that contains an aromatic polycyclic structure.

### TECHNICAL FIELD

The present technical disclosure relates to an ammonia synthesis catalyst, an apparatus for producing ammonia, and a method for producing ammonia.

Specifically, the present technical disclosure relates to an ammonia synthesis catalyst excellent in catalytic activity during ammonia synthesis, an apparatus for producing ammonia, and a method for producing ammonia.

### BACKGROUND ART

Ammonia is an important chemical raw-material used as a basic material for fertilizers and chemical products, and has recently attracted attention for use in mixed combustion for coal-fired power generation and as an energy carrier. Chemical synthesis of ammonia was achieved on a large scale by German researchers, Haber and Bosch, over 100 years ago, using an iron-based catalyst. In the Haber-Bosch process, ammonia is produced by a reaction between nitrogen in the air and hydrogen in fossil fuel, as shown in the following reaction scheme.

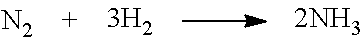

However, the above reaction is performed under high-temperature and high-pressure (400 to 600° C., 100 to 200 atm) conditions. In addition, hydrogen used herein is derived from fossil fuel, and a greenhouse effect gas, i.e., carbon dioxide, is exhausted.

A method for obtaining hydrogen by electrolysis of water using regenerative energy has also been proposed. However, a large apparatus made of a specialized material is required for producing ammonia, and a large amount of energy is required for the production.

Yoshiaki Nishibayashi et al. have found that ammonia can be produced using a predetermined Mo complex as a catalyst and water as a proton source at normal temperature and pressure (Patent Documents 1 and 2 and Non-Patent Document 1).

In addition, Yoshiaki Nishibayashi et al. have successfully synthesized a compound by selenizing a ligand used in a predetermined Mo complex catalyst. In NMR of selenium, they confirmed that a chemical shift value of selenium on the carbene carbon of this compound is correlated with catalytic activity, and found a method for simply evaluating catalytic performance (Patent Document 3 and Non-Patent Document 2).

### RELATED ART DOCUMENTS

### Patent Documents

[Patent Document 1] JP 2010-195703 A
[Patent Document 2] JP 2013-159568 A
[Patent Document 3] WO 2022/025054 A

### Non-Patent Documents

[Non-Patent Document 1]Y. Ashida, K. Arashiba, K. Nakajima, and Y. Nishibayashi, Molybdenum-Catalysed Ammonia Production with Samarium Diiodide and Alcohols or Water, Nature, 2019, 568, 536-540
[Non-Patent Document 2]Y. Ashida, T. Mizushima, K. Arashiba, A. Egi, H. Tanaka, K. Yoshizawa, and Y. Nishibayashi., Catalytic production of ammonia from dinitrogen employing molybdenum complexes bearing N-heterocyclic carbene-based PCP-type pincer ligands, Nature Synthesis, 2023, 2, 635-644

### SUMMARY OF INVENTION

However, in the prior art including Patent Documents 1 to 3 and Non-Patent Documents 1 and 2, room for improvement was found in view of improvement of catalytic activity during synthesis of ammonia.

An object of the present disclosure is to provide an ammonia synthesis catalyst excellent in catalytic activity during ammonia synthesis, an apparatus for producing ammonia, and a method for producing ammonia.

As a result of intensive studies, the present inventors have found that a certain complex is excellent in catalytic activity during ammonia synthesis. Based on the finding, the technique disclosed herein has been accomplished.

According to the present technical disclosure, it is possible to provide the following ammonia synthesis catalyst and others.

1. An ammonia synthesis catalyst, which is a complex comprising a metal ion and a ligand having an aromatic polycyclic structure.

2. The ammonia synthesis catalyst according to 1, wherein the ligand is a pincer type.

3. The ammonia synthesis catalyst according to 1 or 2, wherein coordinating atoms of the ligand are three or more atoms selected from the group consisting of a nitrogen atom (N), a carbon atom (C), a phosphorus atom (P), an arsenic atom (As), a boron atom (B) and a silicon atom (Si).

4. The ammonia synthesis catalyst according to any one of 1 to 3, wherein coordinating atoms of the ligand are two phosphorus atoms and one carbon atom (PCP form), two phosphorus atoms and one nitrogen atom (PNP form), two arsenic atoms and one nitrogen atom (AsNAs form), two phosphorus atoms and one boron atom (PBP form), two sulfur atoms and one carbon atom (SCS form), three nitrogen atoms (NNN form), two phosphorus atoms and one silicon atom (PSiP form), or three phosphorus atoms (PPP form).

5. The ammonia synthesis catalyst according to any one of 1 to 4, wherein the complex is represented by the following formula (1) or the following formula (2):

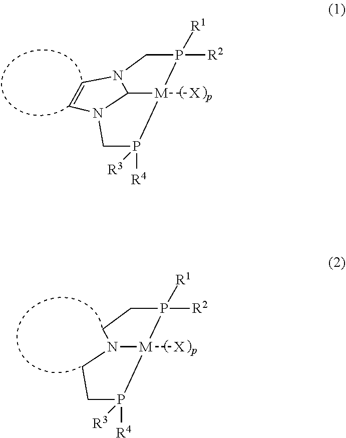

wherein in the formulas (1) and (2),
M is the metal ion,
X is a ligand,
R¹ to R⁴ independently represent an alkyl group having 1 to 6 carbon atoms,
p is an integer of 0 to 5; when p is 2 or more, two or more X's may be different from or the same as each other;
the ring represented by a broken line represents the aromatic polycyclic structure; and
the aromatic polycyclic structure has one or more substituents, or it has no substituents.

6. The ammonia synthesis catalyst according to any one of 1 to 5, wherein the number of rings constituting the aromatic polycyclic structure is 2 to 5.

7. The ammonia synthesis catalyst according to any one of 1 to 6, wherein the number of rings constituting the aromatic polycyclic structure is 2 to 3.

8. The ammonia synthesis catalyst according to any one of 1 to 7, wherein the metal ion is a Mo ion, a Re ion, a Mn ion, a Co ion, a Fe ion, a Cr ion, an Os ion, a Ti ion, a V ion or a Ru ion.

9. The ammonia synthesis catalyst according to any one of 1 to 8, wherein the metal ion is a Mo ion.

10. An apparatus for producing ammonia comprising the ammonia synthesis catalyst according to any one of 1 to 9.

11. A method for producing ammonia using the ammonia synthesis catalyst according to any one of 1 to 9.

According to the present technical disclosure, it is possible to provide an ammonia synthesis catalyst excellent in catalytic activity during ammonia synthesis, an apparatus for producing ammonia, and a method for producing ammonia.

### BRIEF DESCRIPTION OF DRAWINGS

FIG. 1 is a diagram schematically illustrating an example of an apparatus for producing ammonia for carrying out a method for producing ammonia.

FIG. 2 is a schematic view illustrating another example of the apparatus for producing ammonia for carrying out the method for producing ammonia.

### DESCRIPTION OF EMBODIMENTS

Hereinafter, an ammonia synthesis catalyst, an apparatus for producing ammonia, and a method for producing ammonia of the present disclosure will be described in detail.

In the present specification, “x to y” represents a numerical range of “x or more and y or less”. The upper limits and lower limits of the numerical ranges disclosed herein can be arbitrarily used in combination.

In addition, in the present specification, “n” represents normal, “i” represents iso, “s” represents secondary, “t” represents tertiary, “c” represents cyclo, “o” represents ortho, “m” represents meta, and “p” represents para. Further, “Me” represents a methyl group, “Et” represents an ethyl group, “tBu” represents a tertiary-butyl group, and “THF” represents tetrahydrofuran.

### 1. Ammonia Synthesis Catalyst

An ammonia synthesis catalyst according to an aspect (also referred to as a first aspect) of the present technical disclosure is a complex containing a metal ion and a ligand having an aromatic polycyclic structure.

According to the ammonia synthesis catalyst of the first aspect, an effect, i.e., excellent catalytic activity during ammonia synthesis, is obtained.

In one embodiment, the metal ion is a Mo ion, a Re ion, a Mn ion, a Co ion, a Fe ion, a Cr ion, an Os ion, a Ti ion, a V ion or a Ru ion. This can bring about an effect, i.e., a suitable activation of a stable nitrogen molecule.

In one embodiment, the metal ion is a Mo ion.

In the present specification, the “aromatic polycyclic structure” refers to a fused ring, which is formed by fusion of two or more aromatic rings.

However, when the complex contains a five-membered ring having a coordinating atom, the ring does not correspond to the ring constituting the “aromatic polycyclic structure”.

In one embodiment, a plurality of rings constituting an aromatic polycyclic structure are mutually fused.

In one embodiment, the aromatic polycyclic structure is a fused ring formed by fusing a plurality of aromatic rings.

In one embodiment, the number of rings constituting the aromatic polycyclic structure is 2 to 10, 2 to 8, 2 to 6, 2 to 5, 2 to 4, or 2 to 3.

The number of atoms forming rings constituting the aromatic polycyclic structure is, for example, 5 to 10, 5 to 8, or 5 to 6.

In one embodiment, the aromatic polycyclic structure is constituted of two or more rings selected from the group consisting of a 5-membered ring and a 6-membered ring.

In one embodiment, the aromatic polycyclic structure is constituted only of two or more six-membered rings.

The atoms forming rings constituting the aromatic polycyclic structure may be carbon atoms alone, or may contain not only carbon atoms but also atoms except carbon atoms (hetero atoms such as a nitrogen atom, an oxygen atom, a sulfur atom, a boron atom and a phosphorus atom).

Specific examples of the rings constituting the aromatic polycyclic structure include a benzene ring, a pyridine ring, a pyridazine ring, a pyrimidine ring, a pyrazine ring, and the Ike.

The aromatic polycyclic structure may contain, for example, quinoline, quinoxaline or the like, as a structure partially constituting the aromatic polycyclic structure.

In one embodiment, the aromatic polycyclic structure of the ligand has one or more substituents, or it has no substituents.

In one embodiment, the aromatic polycyclic structure of the ligand has one or more substituents.

The substituent that the aromatic polycyclic structure is not particularly limited and may be, for example, an electron-withdrawing group or the like.

The electron-withdrawing group is also called as an electron-attracting group or an electron-accepting group. According to the electronic theory (this is a theory that interpretation is integrally made as much as possible by focusing on changes in electron density and bonding state of reacting substances), the electron-withdrawing group is referred to a substituent that attracts an electron from a bonding electron side as compared with a hydrogen atom.

Examples of the electron-withdrawing group include a substituent, which has an electron donating nature in view of the mesomeric effect but has a nature greatly contributing to electron withdrawing in view of the inductive effect. Specific examples thereof include a fluorine atom, a chlorine atom, a bromine atom, an iodine atom, —CH₂Cl, —CH═CHNO₂, and the like. Alternatively, examples of the electron-withdrawing group include a substituent having an electron withdrawing nature in view of the mesomeric effect and inductive effect. Specific examples thereof include a quaternary ammonium group accompanying an anion as a counter ion, a trifluoromethyl group, a perfluoroalkyl group, a trichloromethyl group, a cyano group, a nitro group, a formyl group, a carboxylic group, a carbonyl (C₁₋₆ alkyl) group, a carbonyl (C₁₋₆ alkoxy) group, a carbonyl (Ar₆₋₁₀ aryl) group, a carbonylamino group, a carbonyl (C₁₋₆ alkyl) amino group, a carbonyl di(C₁₋₆ alkyl) amino group, a sulfonate group, a sulfonylamino group, a sulfonyl (C₁₋₆ alkyl) amino group, a sulfonyl di(C₁₋₆ alkyl) amino group, an Ar₆₋₁₀ aryl group, and the like.

The C₁₋₆ alkyl represents an alkyl group having 1 to 6 carbon atoms. Herein, specific examples of the alkyl group having 1 to 6 carbon atoms include a methyl group, a trifluoromethyl group, an ethyl group, an i-propyl group, an i-butyl group, a s-butyl group, a t-butyl group, an i-pentyl group, a neopentyl group, a t-pentyl group, a 1,1-dimethylpropyl group, an i-hexyl group, a cyclohexyl group, and the Ike.

The C₁₋₆ alkoxy represents an alkoxy group having 1 to 6 carbon atoms. The alkoxy group having 1 to 6 carbon atoms may be a monovalent group having a C₁₋₆ alkyl bonded to oxygen. Here, specific examples of the alkoxy group having 1 to 6 carbon atoms include a methoxy group, a trifluoromethoxy group, an ethoxy group, an i-propoxy group, an i-butoxy group, a s-butoxy group, a t-butoxy group, an i-pentoxy group, a neopentoxy group, a t-pentoxy group, a 1,1-dimethylpropoxy group, an i-hexoxy group, a cyclohexoxy group, and the like.

The Ar₆₋₁₀ aryl represents a substituent obtained by removing one hydrogen atom from an aromatic ring of an aromatic hydrocarbon having 6 to 10 carbon atoms. Specific examples of the Ar₆₋₁₀ aryl include a phenyl group, a phenyl group having a substituent at at least one of 2-position to 6-position, a 1-naphthyl group, a 1-naphthyl group having a substituent at at least one of 2-position to 8-position, a 2-naphthyl group, a 2-naphthyl group having a substituent at at least one of 1-position and 3-position to 8-position, and the like. Examples of the substituent on the aromatic ring of an Ar₆₋₁₀ aryl include halogen atoms such as a fluoro group, a chloro group, a bromo group and an iodo group, and a methyl group, a trifluoromethyl group, an ethyl group, an i-propyl group, an i-butyl group, a s-butyl group and a t-butyl group, and the like. Specific examples of the Ar₆₋₁₀ aryl include a phenyl group, an o-fluorophenyl group, a m-fluorophenyl group, a p-fluorophenyl group, an o-trifluoromethylphenyl group, a m-trifluoromethylphenyl group, a p-trifluoromethylphenyl group, an o-chlorophenyl group, a m-chlorophenyl group, a p-chlorophenyl group, an o-bromophenyl group, a m-bromophenyl group, a p-bromophenyl group, an o-tolyl group, a m-tolyl group, a p-tolyl group, an o-ethylphenyl group, a m-ethylphenyl group, a p-ethylphenyl group, an o-(t-butyl)phenyl group, a m-(t-butyl)phenyl group, a p-(t-butyl)phenyl group, a 3,5-dimethylphenyl group, a 3,5-bistrifluoromethylphenyl group, a 3,4,5-trifluorophenyl group, an o-methoxyphenyl group, a m-methoxyphenyl group, a p-methoxyphenyl group, a 1-naphthyl group, a 2-naphthyl group, a 2-fluoronaphthalen-1-yl group, a 3-fluoronaphthalen-1-yl group, a 4-fluoronaphthalen-1-yl group, a 5-fluoronaphthalen-1-yl group, a 6-fluoronaphthalen-1-yl group, a 7-fluoronaphthalen-1-yl group, an 8-fluoronaphthalen-1-yl group, a 2-chloronaphthalen-1-yl group, a 3-chloronaphthalen-1-yl group, a 4-chloronaphthalene-1-yl group, a 5-chloronaphthalen-1-yl group, a 6-chloronaphthalen-1-yl group, a 7-chloronaphthalen-1-yl group, an 8-chloronaphthalen-1-yl group, a 2-bromonaphthalen-1-yl group, a 3-bromonaphthalen-1-yl group, a 4-bromonaphthalen-1-yl group, a 5-bromonaphthalen-1-yl group, a 6-bromonaphthalen-1-yl group, a 7-bromonaphthalen-1-yl group, an 8-bromonaphthalen-1-yl group, a 2-iodonaphthalen-1-yl group, a 3-iodonaphthalen-1-yl group, a 4-iodonaphthalen-1-yl group, a 5-iodonaphthalen-1-yl group, a 6-iodonaphthalen-1-yl group, a 7-iodonaphthalen-1-yl group, an 8-iodonaphthalen-1-yl group, a 2-methylnaphthalen-1-yl group, a 3-methylnaphthalen-1-yl group, a 4-methylnaphthalen-1-yl group, a 5-methylnaphthalen-1-yl group, a 6-methylnaphthalen-1-yl group, a 7-methylnaphthalen-1-yl group, an 8-methylnaphthalen-1-yl group, a 2-ethylnaphthalen-1-yl group, a 3-ethylnaphthalene-1-yl group, a 4-ethylnaphthalen-1-yl group, a 5-ethylnaphthalen-1-yl group, a 6-ethylnaphthalen-1-yl group, a 7-ethylnaphthalen-1-yl group, an 8-ethylnaphthalen-1-yl group, a 2-i-propylnaphthalen-1-yl group, a 3-i-propylnaphthalen-1-yl group, a 4-i-propylnaphthalen-1-yl group, a 5-i-propylnaphthalen-1-yl group, a 6-i-propylnaphthalen-1-yl group, a 7-i-propylnaphthalen-1-yl group, an 8-i-propylnaphthalen-1-yl group, a 2-i-propylnaphthalen-1-yl group, a 3-i-propylnaphthalen-1-yl group, a 4-i-propylnaphthalen-1-yl group, a 5-i-propylnaphthalen-1-yl group, a 6-i-propylnaphthalen-1-yl group, a 7-i-propylnaphthalen-1-yl group, an 8-i-propylnaphthalen-1-yl group, a 2-c-propylnaphthalen-1-yl group, a 3-c-propylnaphthalen-1-yl group, a 4-c-propylnaphthalen-1-yl group, a 5-c-propylnaphthalen-1-yl group, a 6-c-propylnaphthalen-1-yl group, a 7-c-propylnaphthalen-1-yl group, an 8-c-propylnaphthalen-1-yl group, a 2-i-butylnaphthalen-1-yl group, a 3-i-butylnaphthalen-1-yl group, a 4-i-butylnaphthalen-1-yl group, a 5-i-butylnaphthalen-1-yl group, a 6-i-butylnaphthalen-1-yl group, a 7-i-butylnaphthalen-1-yl group, an 8-i-butylnaphthalen-1-yl group, a 1-fluoronaphthalen-2-yl group, a 3-fluoronaphthalen-2-yl group, a 4-fluoronaphthalen-2-yl group, a 5-fluoronaphthalen-2-yl group, a 6-fluoronaphthalen-2-yl group, a 7-fluoronaphthalen-2-yl group, an 8-fluoronaphthalen-2-yl group, a 1-chloronaphthalen-2-yl group, a 3-chloronaphthalen-2-yl group, a 4-chloronaphthalen-2-yl group, a 5-chloronaphthalen-2-yl group, a 6-chloronaphthalen-2-yl group, a 7-chloronaphthalen-2-yl group, an 8-chloronaphthalen-2-yl group, a 1-bromonaphthalen-2-yl group, a 3-bromonaphthalen-2-yl group, a 4-bromonaphthalen-2-yl group, a 5-bromonaphthalen-2-yl group, a 6-bromonaphthalen-2-yl group, a 7-bromonaphthalen-2-yl group, an 8-bromonaphthalen-2-yl group, a 1-iodonaphthalen-2-yl group, a 3-iodonaphthalen-2-yl group, a 4-iodonaphthalen-2-yl group, a 5-iodonaphthalen-2-yl group, a 6-iodonaphthalen-2-yl group, a 7-iodonaphthalen-2-yl group, an 8-iodonaphthalen-2-yl group, a 1-methylnaphthalen-2-yl group, a 4-methylnaphthalen-2-yl group, an 6-methylnaphthalen-2-yl group, an 8-methylnaphthalen-2-yl group, a 3-ethylnaphthalen-2-yl group, a 5-ethylnaphthalen-2-yl group, a 7-ethylnaphthalen-2-yl group, a 3-methylnaphthalen-2-yl group, a 5-methylnaphthalen-2-yl group, a 7-methylnaphthalen-2-yl group, a 1-ethylnaphthalen-2-yl group, a 4-ethylnaphthalen-2-yl group, a 6-ethylnaphthalen-2-yl group, an 8-ethylnaphthalen-2-yl group, a 1-n-propylnaphthalen-2-yl group, a 3-n-propylnaphthalen-2-yl group, a 4-n-propylnaphthalen-2-yl group, a 5-n-propylnaphthalen-2-yl group, a 6-n-propylnaphthalen-2-yl group, a 7-n-propylnaphthalen-2-yl group, an 8-n-propylnaphthalen-2-yl group, a 1-i-propylnaphthalen-2-yl group, a 3-i-propylnaphthalen-2-yl group, a 4-i-propylnaphthalen-2-yl group, a 5-i-propylnaphthalen-2-yl group, a 6-i-propylnaphthalen-2-yl group, a 7-i-propylnaphthalen-2-yl group, an 8-i-propylnaphthalen-2-yl group, a 1-c-propylnaphthalen-2-yl group, a 3-c-propylnaphthalen-2-yl group, a 4-c-propylnaphthalen-2-yl group, a 5-c-propylnaphthalen-2-yl group, a 6-c-propylnaphthalen-2-yl group, a 7-c-propylnaphthalen-2-yl group, an 8-c-propylnaphthalen-2-yl group, a 1-i-butylnaphthalen-2-yl group, a 3-i-butylnaphthalen-2-yl group, a 4-i-butylnaphthalen-2-yl group, a 5-i-butylnaphthalen-2-yl group, a 6-i-butylnaphthalen-2-yl group, a 7-i-butylnaphthalen-2-yl group, an 8-i-butylnaphthalen-2-yl group, and the Ike.

Examples of the anion, which is a counter ion of the quaternary ammonium group in the electron-withdrawing group include a hexafluorophosphate ion, a hexachloroantimonate ion, a trifluoromethanesulfonate ion, a tetrafluoroborate ion, a phosphate ion, a sulfonate ion, chloride, bromide, iodide, hydroxide, and the like.

Examples of an ammonium cation of the quaternary ammonium group in the electron-withdrawing group include a —NH₃ cation, a —N-mono(C₁₋₁₂ alkyl) H₂ cation, a —N-di(C₁₋₁₂ alkyl) H cation, a —N-tri(C₁₋₁₂ alkyl) cation, a —N-mono(Ar₆₋₁₀ aryl) H₂ cation, a —N-di(Ar₆₋₁₀ aryl) H cation, a —N-tri(Ar₆₋₁₀ aryl) cation, a —N(C₁₋₁₂ alkyl)(Ar₆₋₁₀ aryl) H cation, a —N-di(C₁₋₁₂ alkyl)mono(Ar₆₋₁₀ aryl) cation, or a —N-mono(C₁₋₁₂ alkyl)di(Ar₆₋₁₀ aryl) cation, wherein “—” represents a bond.

The C₁₋₁₂ alkyl in an ammonium cation of the quaternary ammonium group in the electron-withdrawing group independently represent an alkyl group having 1 to 12 carbon atoms. Herein, examples of the alkyl group having 1 to 12 carbon atoms include a methyl group, a trifluoromethyl group, an ethyl group, an i-propyl group, an i-butyl group, a s-butyl group, a t-butyl group, an n-pentyl group, an i-pentyl group, a neopentyl group, a t-pentyl group, a 1,1-dimethylpropyl group, a n-hexyl group, an i-hexyl group, a cyclohexyl group, a 1-methylhexyl group, a n-heptyl group, an i-heptyl group, a 1,1,3,3-tetramethylbutyl group, a 1-methylheptyl group, a 3-methylheptyl group, an i-octyl group, a 2-ethylhexyl group, a 1,1,3-trimethylhexyl group, a 1,1,3,3-tetramethylpentyl group, an i-nonyl group, an i-decyl group, an i-undecyl group, a 1-methylundecyl group, an i-dodecyl group, and the like. Of them, a methyl group, a trifluoromethyl group, an ethyl group, an i-propyl group, an i-butyl group, a t-butyl group, an i-hexyl group, an i-heptyl group, an i-octyl group, a 2-ethylhexyl group, an i-nonyl group, an i-decyl group, an i-undecyl group, and an i-dodecyl group are preferable.

Examples of the Ar₆₋₁₀ aryl in the ammonium cation of the quaternary ammonium group in the electron-withdrawing group include the same as those mentioned above. Of them, a phenyl group, an o-trifluoromethylphenyl group, an m-trifluoromethylphenyl group, a p-trifluoromethylphenyl group, a 3,5-bistrifluoromethylphenyl group, a 3,4,5-trifluorophenyl group, a 1-naphthyl group, and a 2-naphthyl group are preferable.

Examples of the ammonium cation of the quaternary ammonium group in the electron-withdrawing group preferably include a —NH₃ cation, a —N-trimethyl cation, a —N-triethyl cation, or —N-dimethylphenyl cation.

Examples of the perfluoroalkyl group in the electron-withdrawing group include —CF₂CF₃, —(CF₂)₂CF₃, —(CF₂)₃CF₃, —(CF₂)₄CF₃, —(CF₂)₅CF₃, —(CF₂)₆CF₃, —(CF₂)₇CF₃, —(CF₂)₈CF₃, —(CF₂)₉CF₃, —(CF₂)₁₀CF₃, —(CF₂)₁₁CF₃, and the like. Of them, —(CF₂)₉CF₃ and —(CF₂)₁₁CF₃ are preferable.

Examples of the C₁₋₆ alkyl in a carbonyl (C₁₋₆ alkyl) group in the electron-withdrawing group include the same as those mentioned above. Specific examples of the carbonyl (C₁₋₆ alkyl) group preferably include a carbonylmethyl group, a carbonyltrifluoromethyl group, a carbonylethyl group, a carbonyl-n-propyl group, a carbonylisopropyl group, a carbonyl-n-butyl group, a carbonylisobutyl group, a carbonyl-s-butyl group, and a carbonyl-t-butyl group.

Examples of the C₁₋₆ alkoxy in a carbonyl (C₁₋₆ alkoxy) group in the electron-withdrawing group include the same as those mentioned above. Specific examples of the carbonyl (C₁₋₆ alkoxy) group preferably include a carbonylmethoxy group, a carbonyltrifluoromethoxy group, a carbonylethoxy group, a carbonyl-n-propoxy group, a carbonylisopropoxy group, a carbonyl-n-butoxy group, a carbonylisobutoxy group, a carbonyl-s-butoxy group, and a carbonyl-t-butoxy group.

Examples of the Ar₆₋₁₀ aryl in the carbonyl (Ar₆₋₁₀ aryl) group in the electron-withdrawing group include the same as those mentioned above. Specific examples of the carbonyl (Ar₆₋₁₀ aryl) group preferably include a carbonylphenyl group, a carbonyl-o-trifluoromethylphenyl group, a carbonyl-m-trifluoromethylphenyl group, a carbonyl-p-trifluoromethylphenyl group, a carbonyl-3,5-bistrifluoromethylphenyl group, a carbonyl-3,4,5-trifluorophenyl group, a carbonyl-1-naphthyl group, and a carbonyl-2-naphthyl group.

Examples of the C₁₋₆ alkyl in the carbonyl (C₁₋₆ alkyl) amino group in the electron-withdrawing group include the same as those mentioned above. Specific examples of the carbonyl (C₁₋₆ alkyl) amino group preferably include a carbonylmethylamino group, a carbonyltrifluoromethylamino group, a carbonylethylamino group, a carbonyl-n-propylamino group, a carbonylisopropylamino group, a carbonyl-n-butylamino group, a carbonylisobutylamino group, a carbonyl-s-butylamino group, and a carbonyl-t-butylamino group.

Examples of the C₁₋₆ alkyl in the carbonyl di(C₁₋₆ alkyl) amino group in the electron-withdrawing group include the same as those mentioned above. Specific examples of the carbonyl di(C₁₋₆ alkyl) amino group preferably include a carbonyldimethylamino group, a carbonylbis(trifluoromethyl)amino group, a carbonyldiethylamino group, a carbonyl-di-n-propylamino group, a carbonyl-di-isopropylamino group, a carbonyl-di-n-butylamino group, a carbonyl-di-isobutylamino group, a carbonyl-di-s-butylamino group, and a carbonyl-di-t-butylamino group.

Examples of the C₁₋₆ alkyl in the sulfonyl (C₁₋₆ alkyl) amino group in the electron-withdrawing group include the same as those mentioned above. Specific examples of the sulfonyl (C₁₋₆ alkyl) amino group preferably include a sulfonylmethylamino group, a sulfonyltrifluoromethylamino group, a sulfonylethylamino group, a sulfonyl-n-propylamino group, a sulfonylisopropylamino group, a sulfonyl-n-butylamino group, a sulfonylisobutylamino group, a sulfonyl-s-butylamino group, and a sulfonyl-t-butylamino group.

Examples of the C alkyl in the sulfonyl di(C₁₋₆ alkyl) amino group in the electron-withdrawing group include the same as those mentioned above. Specific examples of the sulfonyl di(C₁₋₆ alkyl) amino group preferably include a sulfonyldimethylamino group, a sulfonylbis(trifluoromethyl)amino group, a sulfonyldiethylamino group, a sulfonyldi-n-propylamino group, a sulfonyldiisopropylamino group, a sulfonyldi-n-butylamino group, a sulfonyldiisobutylamino group, a sulfonyldi-s-butylamino group, and a sulfonyldi-t-butylamino group.

Examples of the Ar₆₋₁₀ aryl group in the electron-withdrawing group include the same as those mentioned above. Specific examples of the Ar₆₋₁₀ aryl group preferably include a phenyl group, an o-trifluoromethylphenyl group, a m-trifluoromethylphenyl group, a p-trifluoromethylphenyl group, a 3,5-bistrifluoromethylphenyl group, a 3,4,5-trifluorophenyl group, a 1-naphthyl group, and a 2-naphthyl group.

Of the electron-withdrawing groups mentioned above, —NH₃ cation, —N-trimethyl cation, —N-triethyl cation, —N-dimethylphenyl cation, —(CF₂)₉CF₃ and —(CF₂)₁₁CF₃, a fluorine atom, a chlorine atom and a trifluoromethyl group are preferable, and a fluorine atom, a chlorine atom and a trifluoromethyl group are particularly preferable.

The substituent that the aromatic polycyclic structure is not limited to the electron-withdrawing groups mentioned above, and may be any substituent including substituents other than the electron-withdrawing groups. The substituent that the aromatic polycyclic structure may have can be provided, for example, for the purpose of improving the electronic state and solubility of a complex, and stability thereof as a compound. The aromatic polycyclic structure may not have a substituent.

Examples of the substituents other than the electron-withdrawing groups include hydrocarbon groups other than the electron-withdrawing groups, and the like. Examples of the hydrocarbon groups other than the electron-withdrawing groups include an alkyl group having 1 to 6 carbon atoms, and the like. Specific examples of the alkyl groups having 1 to 6 carbon atoms include a methyl group, an ethyl group, an i-propyl group, an i-butyl group, a s-butyl group, a t-butyl group, an i-pentyl group, a neopentyl group, a t-pentyl group, a 1,1-dimethylpropyl group, an i-hexyl group, a cyclohexyl group, and the like.

In the present aspect, since an electron attractive action is exerted by the aromatic polycyclic structure of a ligand, even when the aromatic polycyclic structure does not have a substituent of an electron-withdrawing group, an effect, i.e., excellent catalytic activity during ammonia synthesis, can be obtained. In contrast, when the aromatic polycyclic structure has a substituent of an electron-withdrawing group, an effect, i.e. further improvement of the catalytic activity during ammonia synthesis, can be obtained.

According to the present aspect, as compared with the case where an electron-withdrawing group is present but an aromatic polycyclic structure is not present (for example, the complex of Non-Patent Document 2), since the aromatic ring structure is enlarged by the presence of an aromatic polycyclic structure, it is possible to obtain an effect, i.e., the ammonia synthesis catalyst easily and stably held on a carbon electrode and the like by intermolecular interaction. In addition, since there are a large number of sites for introducing a substituent, an effect, i.e., the degree of freedom of physical properties can be increased.

In one embodiment, the ligand is a pincer type. As a result, the ligand is coordinated to the metal ion in the three directions. Thus, an effect, improvement of the stability of the ammonia synthesis catalyst, is obtained.

In one embodiment, the coordinating atoms of the ligand are three or more atoms selected from the group consisting of a nitrogen atom (N), a carbon atom (C), a phosphorus atom (P), an arsenic atom (As), a boron atom (B) and a silicon atom (Si). As a result, an effect, i.e., improvement of the stability of the ammonia synthesis catalyst, is obtained.

In one embodiment, the complex is represented by the following formula (A).

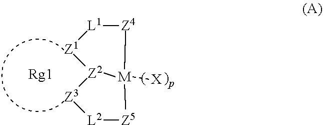

In the formula,
M is a metal ion as mentioned above,
Z¹ to Z³ are independently a carbon atom, a nitrogen atom or a boron atom,
L¹ and L² are independently a single bond or a divalent group,
Z⁴ and Z⁵ are groups containing a coordinating atom,
X is a ligand, and
p is an integer of 0 to 5; when p is 2 or more, two or more X's may be different from or the same as each other. The integer represented by p varies depending on the valence of the metal ion. In the formulas (1) and (2), the bond between M and X is indicated by a single dotted line, but it is not limited to one bond (a single bond), and it may be a double bond or a triple bond.

Rg1 represents an aromatic polycyclic structure.

Z¹ to Z³ represent atoms forming Rg1.

Examples of the divalent group include an alkylene group having 1 to 4 carbon atoms such as a methylene group and an ethylene group, an arylene group such as a phenylene group, and the like.

In the group containing a coordinating atom, examples of the coordinating atom include N, C, P, As, B or Si as mentioned above.

Examples of the group containing a coordinating atom include a hydrocarbon ring containing a coordinating atom, a heterocyclic ring containing a coordinating atom, >PR₂, >NR₂, >AsR₂, and the Ike. R represents an alkyl group, an aryl group such as a phenyl group, or an aliphatic hydrocarbon ring group such as an adamantyl group.

In one embodiment, the coordinating atoms of the ligand are two phosphorus atoms and one carbon atom (PCP form, a Z⁴Z²Z⁵ form if represented by the formula (A)); two phosphorus atoms and one nitrogen atom (PNP form); two arsenic atoms and one nitrogen atom (AsNAs form); two phosphorus atoms and one boron atom (PBP form); two sulfur atoms and one carbon atom (SCS form); three nitrogen atoms (NNN form); two phosphorus atoms and one silicon atom (PSIP form); or three phosphorus atoms (PPP form).

In one embodiment, the complex is represented by the following formula (1) or the following formula (2).

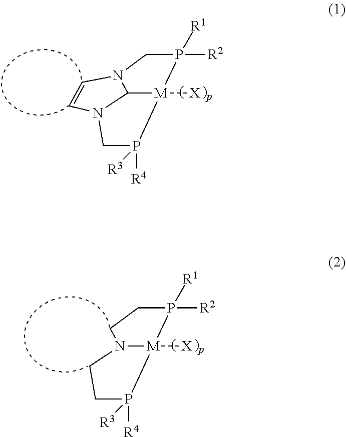

In the formulas (1) and (2),
M is a metal ion as mentioned above,
X is a ligand,
R¹ to R⁴ independently represent an alkyl group having 1 to 6 carbon atoms, and
p is an integer of 0 to 5. When p is 2 or more, two or more X's may be different from or the same as each other. The integer represented by p varies depending on the valence of the metal ion. In the formulas (1) and (2), the bond between M and X is indicated by a single dotted line, but it is not limited to one bond (a single bond), and it may be a double bond or a triple bond.

The ring represented by a broken line represents the aromatic polycyclic structure.

The aromatic polycyclic structure has one or more substituents, or it has no substituents.

In one embodiment, X's are the same as each other. Examples of the ligand represented by X include a halogen atom, a nitrogen atom, and the like.

Examples of the alkyl group having 1 to 6 carbon atoms of R¹ to R⁴ include a methyl group, a trifluoromethyl group, an ethyl group, an i-propyl group, an i-butyl group, a s-butyl group, a t-butyl group, an i-pentyl group, a neopentyl group, a t-pentyl group, a 1,1-dimethylpropyl group, an i-hexyl group, a cyclohexyl group, and the like.

The number of carbon atoms in the alkyl group of R¹ to R⁴ is preferably 2 to 6, and more preferably 3 to 6.

In one embodiment, R¹ to R⁴ are the same as each other.

In one embodiment, the complex is represented by the following formula (1A) or (2A).

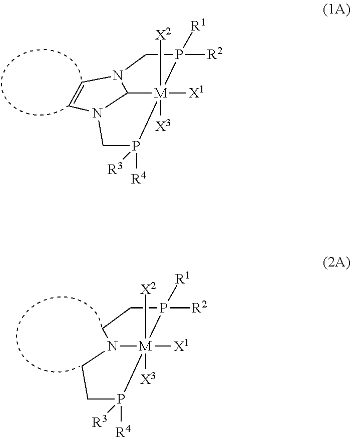

In the formulas (1A) and (2A),
M is a metal ion as mentioned above,
X¹ to X³ independently represent an iodine atom, a bromine atom, or a chlorine atom,
R¹ to R⁴ independently represent an alkyl group having 1 to 6 carbon atoms, and
the ring represented by a broken line represents an aromatic polycyclic structure as mentioned above.

The aromatic polycyclic structure has one or more substituents, or it has no substituents.

In one embodiment, X¹ to X³ are the same as each other.

Examples of the aromatic polycyclic structure in the formulas (1) and (1A) include the following structures. In the following aromatic polycyclic structures, a portion represented by a broken line represents a fused portion (a portion shared with the ring structure represented by a solid line in the formula (1) or (1A)).

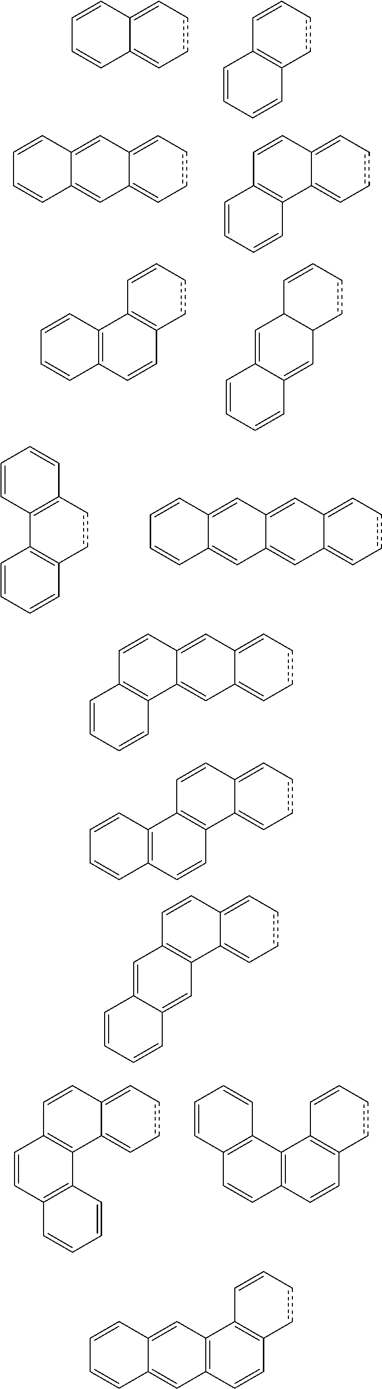

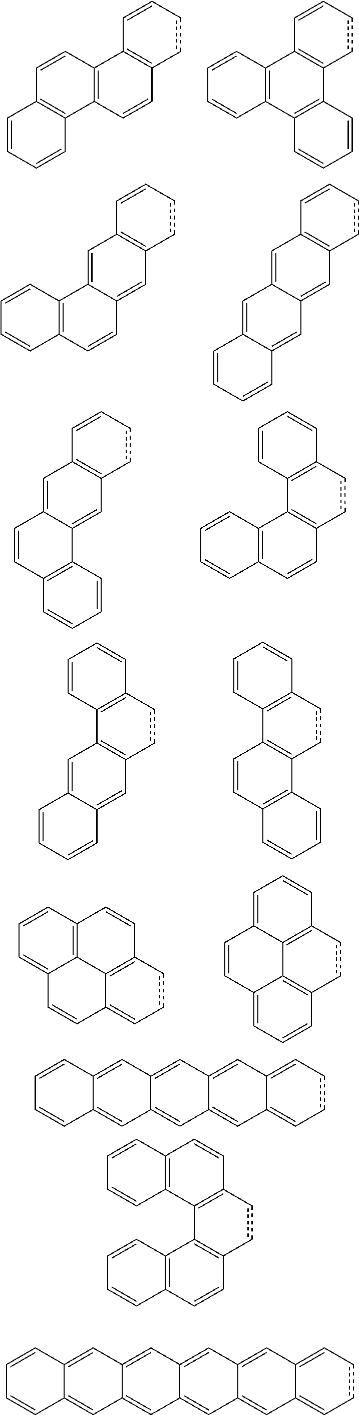

Examples of the aromatic polycyclic structure in the formulas (2) and (2A) include the following structures. In the following aromatic polycyclic structures, a broken line represents a fused portion (a portion shared with the ring structure represented by a solid line in the formula (2) and the formula (2A)).

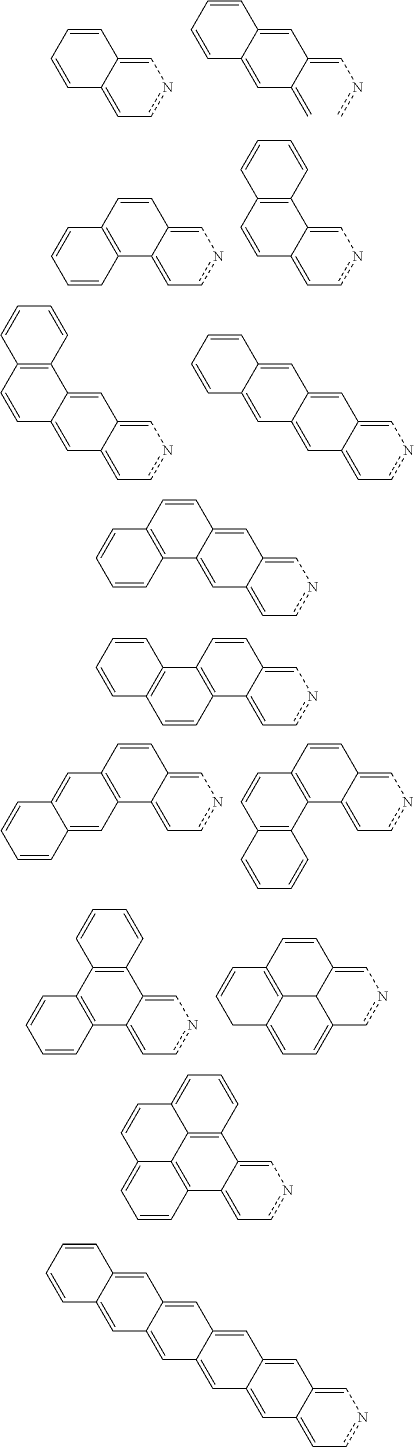

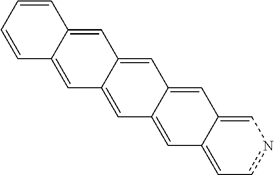

In the aromatic polycyclic structures shown above, one or more ring-forming atoms of one or more rings may be replaced with atoms other than carbon atoms, and one or more rings may be replaced with 5-membered rings.

In the aromatic polycyclic structure shown above, one or more hydrogen atoms may be substituted with substituents.

Specific examples of the complex include the following complexes. In the following specific examples, R is a substituent, and n is an integer of 0 or 1 or more. Examples of the substituent R include those mentioned as the substituent that the aromatic polycyclic structure may have.

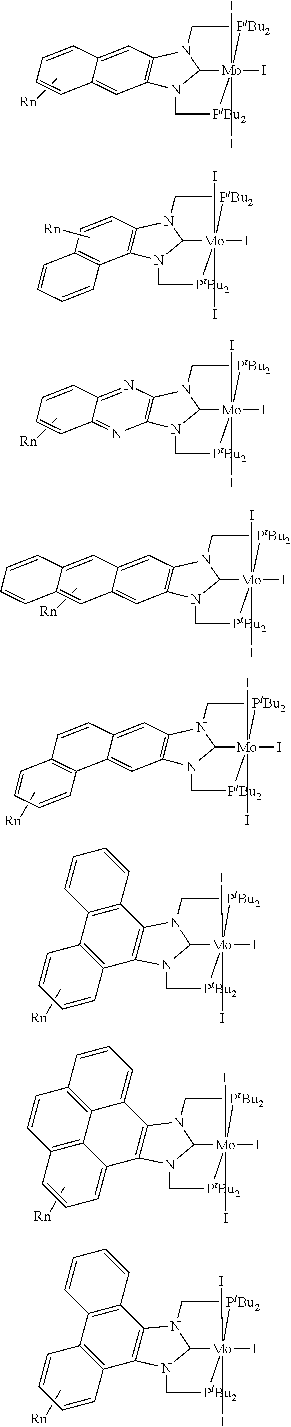

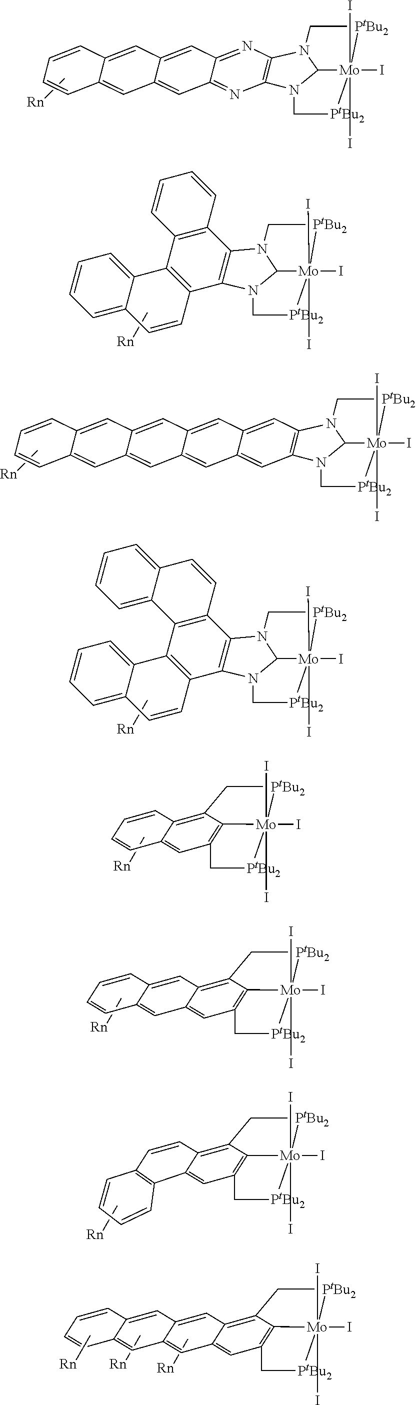

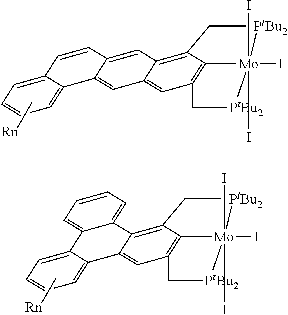

In the above examples, the case where a predetermined ring constituting an aromatic polycyclic structure may have substituent R is shown, but the present invention is not limited to the case, and one or more rings other than the predetermined ring constituting the aromatic polycyclic structure may also have substituent R.

In one embodiment, the complex having a Mo ion as the metal ion has an N—H bond dissociation free energy (BDFE) of 34.0 to 45.0 kcal/mol, which is the difference between the Gibbs free energy of a nitride complex (which varies depending on the structure of an original complex, and an example of the structural formula is shown below) obtained by activating a nitrogen molecule and the Gibbs free energy of an imide complex (which varies depending on the structure of the original complex, and an example of the structural formula is shown below) obtained by hydrogenating the nitride complex. Because of this, the catalytic activity during ammonia synthesis is further improved.

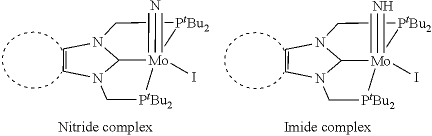

In the present specification, when the BDFE of N—H is obtained, to a Mo ion in the nitride complex, an iodine atom (1) is assumed to be bonded (see the above formula). The same applies to the imide complex (Mo═N—H).

For example, the nitride complexes corresponding to the complexes synthesized in Examples 1 and 3 (described later) are respectively represented by the following formulas (3) and (4).

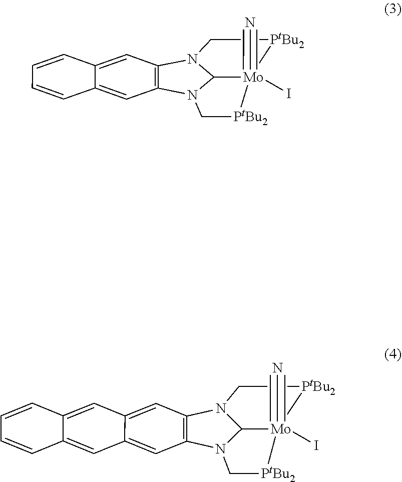

The BDFE of N—H can be obtained by quantum chemical calculation. The quantum chemical calculation is carried out using general purpose—software Gaussian09 (Revision E.01 manufactured by Gaussian). A density functional theory method (DFT method) is used, and B3LYP-D3 is selected as a functional. As a basis function, 6-31G (d) is used for a typical element from H to Kr in the periodic table, and SDD is used for transition elements and heavy elements. In the calculation, the stable structure of a nitride complex ([ligand] Mo(I)≡N) is obtained; further, the structure of [ligand] Mo(I)═N—H is optimized. Based on the difference in Gibbs free energy between the two structures, BDFE is calculated. The reference symbol “(I)” represents an iodine atom bonded to a Mo atom.

When the BDFE is 34.0 kcal/mol or more, the catalytic activity during ammonia synthesis is further improved. The reason is considered, for example, as follows: the reaction between N of Mo (I)≡N, which is generated when the complex activates the nitrogen molecule and cleaves the triple bond of N≡N, and a proton is a rate-determining reaction during ammonia synthesis, but since BDFE is large, the rate determining reaction is likely to occur. In contrast, when the BDFE is 45.0 kcal/mol or less, since the strength of the Mo═N bond is suppressed from excessively increasing, it is possible to prevent a reduction of the reaction rate.

The ammonia synthesis catalyst according to another aspect (also referred to as a second aspect) of the present technical disclosure is a complex containing a Mo ion and having an N—H bond dissociation free energy (BDFE) of 34.0 to 45.0 kcal/mol, which is obtained from the difference between a Gibbs free energy of the nitride complex and the Gibbs free energy of the imide complex.

Also, the ammonia synthesis catalyst according to the second aspect can provide an effect, an excellent catalytic activity during ammonia synthesis.

The ammonia synthesis catalyst according to the second aspect is not limited to the ammonia synthesis catalyst according to the first aspect. To be more specific, the ammonia synthesis catalyst according to the second aspect is satisfactory as long as it satisfies the BDFE condition mentioned above, and it is not essential for the ligand of the complex to contain an aromatic polycyclic structure (the ligand of the complex may or may not have an aromatic polycyclic structure). To the ammonia synthesis catalyst according to the second aspect, the description of the ammonia synthesis catalyst according to the first aspect is appropriately applied except that it is not essential for the ligand of the complex to contain an aromatic polycyclic structure.

### 2. Apparatus for Producing Ammonia, and Method for Producing Ammonia

The apparatus for producing ammonia according to an aspect of the present technical disclosure has either one or both of the ammonia synthesis catalyst according to the first aspect and the ammonia synthesis catalyst according to the second aspect. According to the present aspect, since the ammonia synthesis catalyst has excellent catalytic activity during ammonia synthesis, ammonia can be efficiently produced.

The method for producing ammonia according to an aspect of the present technical disclosure employs either one or both of the ammonia synthesis catalyst according to the first aspect and the ammonia synthesis catalyst according to the second aspect. According to the present aspect, since the ammonia synthesis catalyst has excellent catalytic activity during ammonia synthesis, ammonia can be efficiently produced.

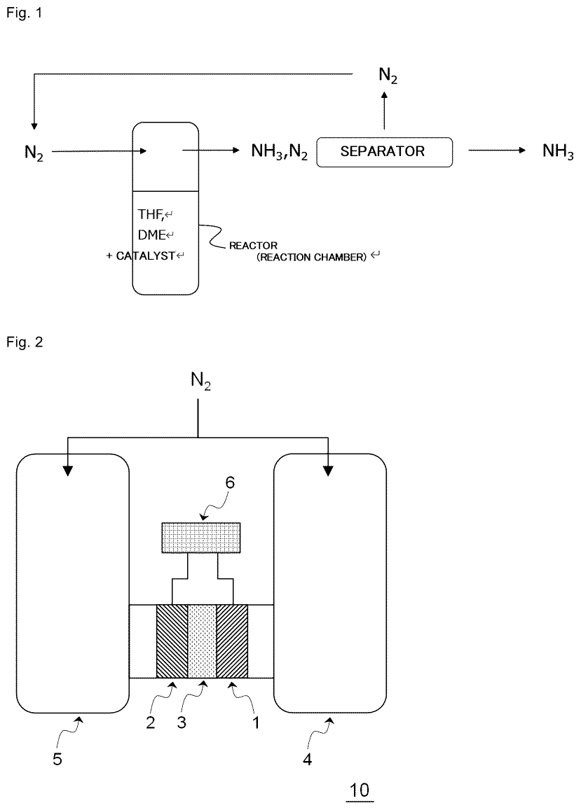

FIG. 1 is a diagram schematically illustrating an example of an apparatus for producing ammonia for carrying out a method for producing ammonia.

The apparatus for producing ammonia illustrated in the figure has a reactor. The reactor is composed of a material excellent in chemical resistance. A Schlenk tube and the like can be used, in which a reaction can be performed without problem even when an organic solvent and ammonia are present.

To the reaction chamber, a stirrer (not shown) is connected. A reaction can be promoted by stirring the solvent in the reaction chamber by the stirrer.

As the solvent, for example, dimethoxyethane (DME) or THF can be used.

To the reaction chamber, a supply pipe (not shown) for supplying nitrogen (N₂) into the chamber is connected to keep a nitrogen atmosphere of the reaction chamber at all times.

To the reaction chamber, an exhaust pipe (not shown) for exhausting generated ammonia (NH₃) is connected. It is constituted such that ammonia exhausted from the exhaust pipe is diffused, it passes, for example, through a separator employing cryogenic separation and the like, and, as a result, raw-material nitrogen is separated to purify ammonia. The separated nitrogen can be used again as a raw material.

An example of the method for producing ammonia using the above apparatus for producing ammonia will be described.

First, deoxygenated THF (and/or DME), a catalyst (either one or both of the ammonia synthesis catalyst according to the first aspect and the ammonia synthesis catalyst according to the second aspect), samarium iodide, and deoxygenated water are added.

While supplying nitrogen (N₂) from a supply tube into the reactor, the reaction is carried out with stirring by a stirrer at room temperature.

The generated ammonia (NH₃) is exhausted from the exhaust pipe, and purified by removing raw-material nitrogen within the separator.

The reaction is terminated by adding an aqueous potassium hydroxide solution in the reactor. Ammonia in the solution is allowed to release to collect dissolved ammonia.

Thereafter, the remaining solution is distilled separately and used again.

The apparatus for producing ammonia, and the method for producing ammonia according to the present aspect are not limited to the above examples.

The apparatus for producing ammonia, and the method for producing ammonia according to the present aspect may be, for example, one in which nitrogen and a proton source (proton) are reacted to generate ammonia, and which is constituted such that either one or both of the ammonia synthesis catalyst according to the first aspect and the ammonia synthesis catalyst according to the second aspect have action to the reaction.

In one embodiment, the ammonia generation reaction is carried out at normal temperature and normal pressure using water as a proton source.

The reaction temperature and pressure in the ammonia generation reaction are not particularly limited.

In one embodiment, the reaction temperature is 0 to 100° C.

In one embodiment, the reaction pressure is 0.1 to 200 atm.

In one embodiment, the reaction pressure is less than 100 atm, and it is, for example, 0.1 atm or more and less than 100 atm.

### <Electrochemical Reduction Reaction>

In the method for producing ammonia according to the present aspect, in one embodiment, ammonia is synthesized from nitrogen and a proton source by an electrochemical reduction reaction.

The electrochemical reduction reaction includes, for example, a step of synthesizing ammonia from nitrogen and a proton source in the presence of either one or both of the ammonia synthesis catalyst according to the first aspect and the ammonia synthesis catalyst according to the second aspect (hereinafter, simply referred to as a “catalyst”) and a reducing agent, and at the same time, electrolytically reducing the reducing agent oxidized in the ammonia synthesis reaction.

The phrase “at the same time” herein means that the step is performed in the same system. The time interval between the synthesis of ammonia and the reduction of the oxidized reducing agent is preferably short.

As an example, the step can be carried out in accordance with the disclosure of WO 2022/230898 A.

Specifically, a catalyst is supplied on the cathode side of the electrolysis cell, a reaction with nitrogen is performed simultaneously with a reaction with protons supplied from the anode side to produce ammonia. When the proton source is water and a proton-coupled electron transfer mediator is used, it is presumed that ammonia is continuously generated by the mechanism shown in reaction schemes (1) to (6) or reaction schemes (7) to (12).

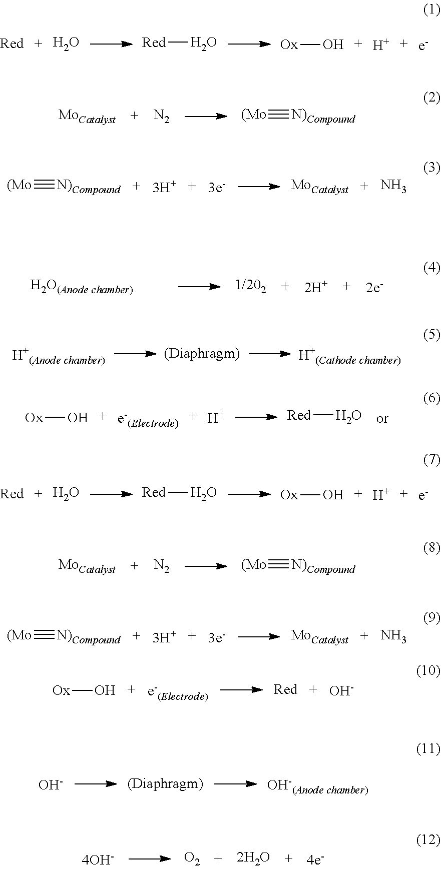

In the schemes, Red represents a reducing agent, Ox represents an oxidized reducing agent, and Cat represents a catalyst.

The protons H⁺ in the reaction (2) can be donated from a proton source added in a cathode chamber or from an anode chamber through a diaphragm.

More specifically, in the method for producing ammonia according to one embodiment, for example, when ammonia (NH₃) is synthesized each using an electrolysis cell as an apparatus for producing ammonia, using either one or both of the ammonia synthesis catalyst according to the first aspect and the ammonia synthesis catalyst according to the second aspect (hereinafter, also referred to as “Mocat”) as a catalyst, using samarium iodide (SmI₂) as a reducing agent, and using water (H₂O) as a proton source, it is considered that ammonia is continuously synthesized through the reactions shown in the following (A) to (C). The reaction scheme shown in the following (B) is described including the reaction shown in the following (A) that proceeds in coupling to the NH₃ generation reaction.

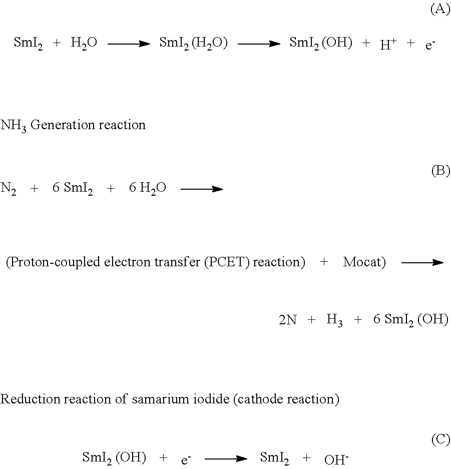

Ammonia can also be produced in a step of electrolytically reducing the reducing agent. The reactor, electrodes, and solvent to be used in this reaction can be freely selected.

FIG. 2 is a schematic view showing another example of the apparatus for producing ammonia for carrying out the method for producing ammonia, where the apparatus for producing ammonia has an electrolysis cell.

In FIG. 2, reference numeral 10 denotes an apparatus for producing ammonia, reference numeral 1 denotes a cathode electrode, reference numeral 2 denotes an anode electrode, reference numeral 3 denotes a diaphragm (for example, an ion exchange membrane and the like), reference numeral 4 denotes a cathode chamber, reference numeral 5 denotes an anode chamber, and reference numeral 6 denotes a power supply.

Specifically, for example, a proton source such as water is used in the anode tank, titanium or a carbon material is used as the cathode electrode 1, and nickel or a carbon material is used as the anode electrode 2. A catalyst to which a voltage is applied from the power supply 6, a reducing agent, a proton source, and a solvent are added to the cathode chamber 4. A proton supply source such as water is added in the anode chamber 5.

The catalyst reacts with nitrogen molecules supplied to the cathode chamber 4 to activate the nitrogen molecules; protons are supplied to the nitrogen; and electrons are further supplied, to reduce a metal. This process is repeated to generate ammonia. When the reducing agent uses electrons as a mediator, the oxidized reducing agent is reduced by the cathode electrode 1 and put in recycle use.

As mentioned above, the apparatus for producing ammonia according to an aspect of the present technical disclosure has either one or both of the ammonia synthesis catalyst according to the first aspect and the ammonia synthesis catalyst according to the second aspect.

In one embodiment, the apparatus for producing ammonia produces ammonia by the method for producing ammonia according to an aspect of the present invention.

As long as the apparatus for producing ammonia has the catalyst and is preferably constructed to perform the method for producing ammonia, the specific structure of the apparatus is not limited.

The apparatus for producing ammonia may appropriately have, for example, the structure shown in FIG. 1 or 2 mentioned above.

### EXAMPLES

Examples of the present technical disclosure will be described below, but the present technical disclosure is not limited to these Examples.

### Example 1

### Synthesis of Ammonia Synthesis Catalyst (Complex)

To a reaction vessel, tBu₂PH (10.0 g, 68.4 mmol) and paraformaldehyde (1.90 g, 63.1 mmol, 0.90 eq.) were added and mixed. Thereafter, 2,3-diaminonaphthalene (5.00 g, 31.6 mmol, 0.46 eq.) was added to the mixture and stirred. A solid thus obtained was extracted with hexane and recrystallized from hexane to obtain compound 1 (colorless and transparent crystal) (amount: 11.2 g, yield: 66%).

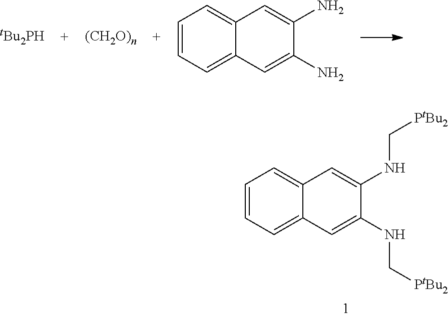

Compound 1 (11.2 g, 20.7 mmol), selenium (3.23 g, 41.5 mmol, 2.00 eq.) and toluene (120 mL) were added to a reaction vessel, and stirred. A crude product thus obtained was purified by silica gel chromatography to obtain compound 2 (white solid substance) (amount: 9.85 g, yield: 75%).

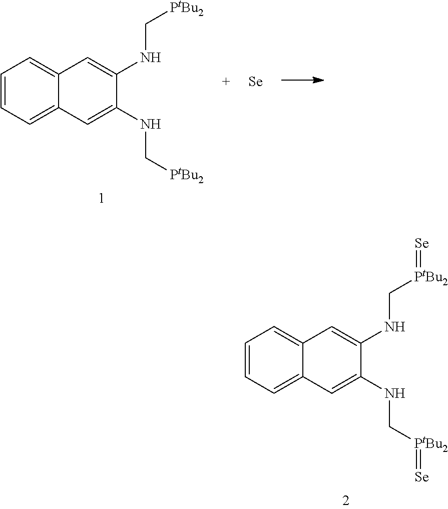

Compound 2 (9.85 g, 15.5 mmol), NH₄PF₆ (2.52 g, 15.5 mmol, 1.00 eq.) and triethyl orthoformate (30.0 mL, 180 mmol, 11.6 eq.) were added to the reaction vessel, and stirred. A solid thus obtained was washed with a dichloromethane/diethyl ether (2/5) solution and dried to obtain compound 3 (white solid substance) (amount: 11.8 g, yield: 96%).

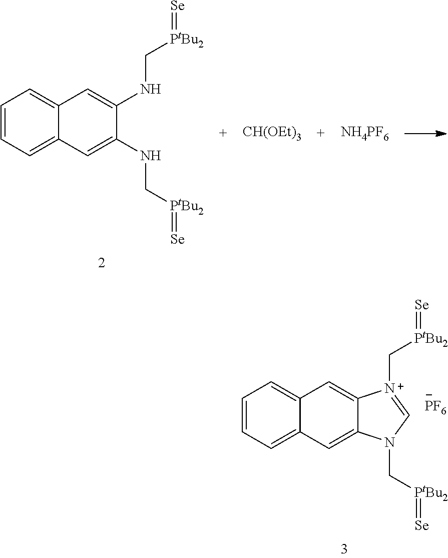

Compound 3 (3.00 g, 3.80 mmol), tris(dimethylamino)phosphine (2.0 mL), and dichloromethane (50 mL) were added to a reaction vessel, and stirred. A solid thus obtained was washed with toluene and dried to obtain compound 4 (white solid substance) (amount: 2.11 g, yield: 88%).

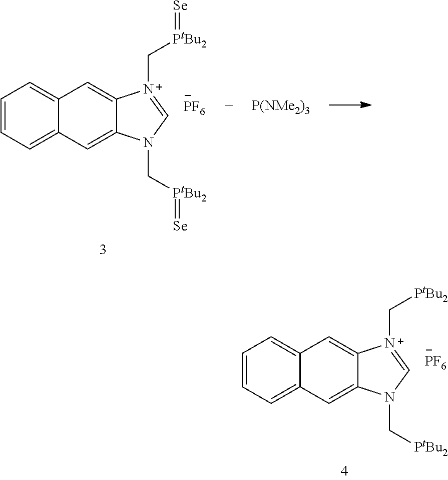

Compound 4 (1.61 g, 2.55 mmol), a toluene solution of KN (SiMe₃)₂ (concentration in toluene 15% by mass, 5.56 mL, and 3.62 mmol as KN (SiMe₃)₂, 1.40 eq.) and toluene (51.7 mL) were added to a reaction vessel, and stirred. Thereafter, MoI₃(THF)₃ (1.57 g, 2.26 mmol, 0.88 eq.) dissolved in toluene (19.4 mL) was added and stirred under reflux conditions. A solid thus obtained was washed sequentially with hexane and toluene. Subsequently, the solid substance was dried, extracted with methylene chloride, and recrystallized by adding hexane to obtain complex 5 (black solid substance) (amount: 750 mg, yield: 31%).

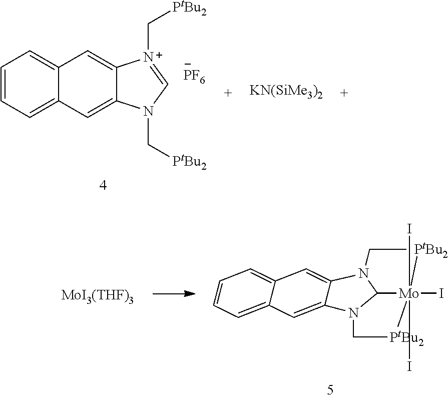

For complex 5, the BDFE (bond dissociation free energies) of N—H, which is the difference between the Gibbs free energy when the σ bond of the Mo ion was converted into Mo N and the Gibbs free energy when the σ bond of the Mo ion was converted into Mo═N—H, was obtained by the aforementioned method. The calculation method is as mentioned above.

### Example 2

### Ammonia Synthesis

Ammonia was produced from nitrogen molecules using the complex 5 synthesized as a catalyst in Example 1. To a reaction vessel, 5.54 mg (5.0 μmol) of complex 5, 10 mL of THF, and 0.9 mmol of samarium iodide as a reducing agent were added. Further, 16.2 mg (900 μmol) of water as a proton source was added. The mixture was stirred at 20 to 25° C. as room temperature for 30 minutes. Thereafter, an aqueous potassium hydroxide solution (30% by mass, 5 mL) was added to the reaction solution to terminate the reaction. In order to quantify the amount of ammonia produced by the reaction, the reaction vessel was subjected to distillation under reduced pressure, and the distillate was collected with a 1% aqueous sulfuric acid solution (10 mL). The amount of ammonia in the aqueous sulfuric acid solution was determined by ion chromatography. As a result, 55 equivalents of ammonia were produced per catalyst (complex 5). After 30 minutes from the initiation of the reaction, the TOF, which is a turnover frequency of the catalyst, was 277 (1/min).

### Example 3

In the synthesis of the ammonia synthesis catalyst (complex) of Example 1, 2,3-diaminoanthracene was used in place of 2,3-diaminonaphthalene to obtain complex 6 shown below.

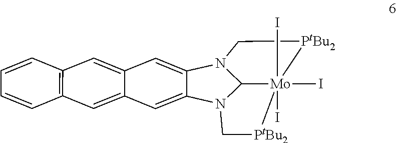

When BDFE of N—H for complex 6 was determined, it was 37.6 kcal/mol.

### Example 4

Ammonia was produced from nitrogen molecules using anthracene complex 6 as a catalyst. To a reaction vessel, anthracene complex 6 (5.79 mg, 5.0 μmol), 10 mL of THF, and diiodobis(tetrahydrofuran)samarium (II) (494 mg, 900 μmol, 180 equivalents to the mole number of molybdenum complex) as a reducing agent were added, and subsequently, water (16.2 mg, 900 μmol, 180 equivalents to mole number of complex 6) as a proton source was added. The mixture was stirred at 20° C. to 25° C. as room temperature for 5 minutes. To terminate the reaction, an aqueous potassium hydroxide solution (30% by mass, 5 mL) was added to the reaction vessel. Next, in order to quantify the amount of ammonia produced in the reaction, the reaction vessel was subjected to distillation under reduced pressure, and the distillate was collected with a 1% aqueous sulfuric acid solution (10 mL). The amount of ammonia in the aqueous sulfuric acid solution was determined by ion chromatography. As a result, 57 equivalents of ammonia were produced per catalyst (complex 6). After 30 minutes from the initiation of the reaction, the TOF, which is the turnover frequency of the catalyst, was 295 (1/min).

### Comparative Example 1

### Synthesis of Ammonia Synthesis Catalyst (Complex)

In the synthesis of the ammonia synthesis catalyst (complex) of Example 1, 1,2-diaminobenzene was used in place of 2,3-diaminonaphthalene to obtain complex 7 shown below.

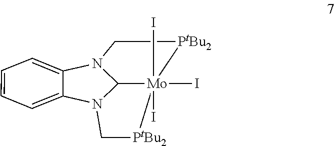

When BDFE of N—H for complex 7 was obtained, it was 33.8 kcal/mol.

### Ammonia Synthesis

Ammonia was synthesized in the same manner as in Example 2 except that complex 7 shown below was used in place of complex 5. As a result, ammonia (56 equivalents of per catalyst (complex 7)) was produced. After 30 minutes from the initiation of the reaction, the TOF, which is the turnover frequency of the catalyst, was 205 (1/min).

The above results are shown in Table 1. Comparative Example 1 shows ammonia synthesis using a conventional catalyst. It was confirmed that TOFs (ammonia synthesis rates) of Examples are beyond that of Comparative Example 1.

TABLE 1

| | BDFE | TOF after 30 minutes |
|---|---|---|
| | (kcal/mol) | (1/min) |
| Example 2 | 35.7 | 277 |
| Example 4 | 37.6 | 295 |
| Comparative | 33.8 | 205 |
| Example 1 | | |

Several embodiments and/or Examples of the present invention have been described in detail, above. It is easy for those skilled in the art to add numerous modifications to these embodiments and/or Examples without substantially departing from the teachings newly provided and effects of the present invention. Therefore, these numerous modifications fall within the scope of the present invention.

All literatures cited in this specification, and the contents of the applications on which the priority claim under the Paris Convention is based, are incorporated herein in their entirety by reference.

1. An ammonia synthesis catalyst, which is a complex comprising a metal ion and a ligand having an aromatic polycyclic structure.

2. The ammonia synthesis catalyst according to claim 1, wherein the ligand is a pincer type.

3. The ammonia synthesis catalyst according to claim 1, wherein coordinating atoms of the ligand are three or more atoms selected from the group consisting of a nitrogen atom (N), a carbon atom (C), a phosphorus atom (P), an arsenic atom (As), a boron atom (B) and a silicon atom (Si).

4. The ammonia synthesis catalyst according to claim 1, wherein coordinating atoms of the ligand are two phosphorus atoms and one carbon atom (PCP form), two phosphorus atoms and one nitrogen atom (PNP form), two arsenic atoms and one nitrogen atom (AsNAs form), two phosphorus atoms and one boron atom (PBP form), two sulfur atoms and one carbon atom (SCS form), three nitrogen atoms (NNN form), two phosphorus atoms and one silicon atom (PSiP form), or three phosphorus atoms (PPP form).

5. The ammonia synthesis catalyst according to claim 1, wherein the complex is represented by the following formula (1) or the following formula (2): 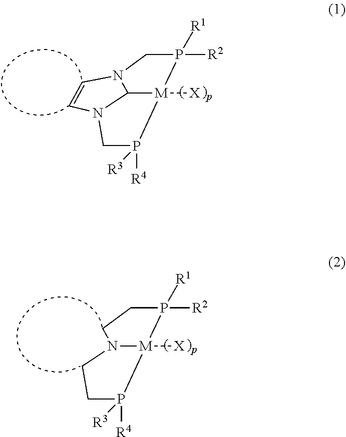
wherein in the formulas (1) and (2),
M is the metal ion,
X is a ligand,
R¹ to R⁴ independently represent an alkyl group having 1 to 6 carbon atoms,
p is an integer of 0 to 5; when p is 2 or more, two or more X's may be different from or the same as each other;
the ring represented by a broken line represents the aromatic polycyclic structure; and
the aromatic polycyclic structure has one or more substituents, or it has no substituents.

6. The ammonia synthesis catalyst according to claim 1, wherein the number of rings constituting the aromatic polycyclic structure is 2 to 5.

7. The ammonia synthesis catalyst according to claim 1, wherein the number of rings constituting the aromatic polycyclic structure is 2 to 3.

8. The ammonia synthesis catalyst according to claim 1, wherein the metal ion is a Mo ion, a Re ion, a Mn ion, a Co ion, a Fe ion, a Cr ion, an Os ion, a Ti ion, a V ion or a Ru ion.

9. The ammonia synthesis catalyst according to claim 1, wherein the metal ion is a Mo ion.

10. An apparatus for producing ammonia comprising the ammonia synthesis catalyst according to claim 1.

11. A method for producing ammonia using the ammonia synthesis catalyst according to claim 1.
